(19) United States
(12) Patent Application Publication
(10) Pub. No.: US 2024/0228723 A9
(43) Pub. Date: Jul. 11, 2024

(54) HIGH MELT STRENGTH POLYPROPYLENE COMPOSITION

(71) Applicant: SABIC Global Technologies B.V., Bergen op Zoom (NL)

(72) Inventors: Peter Degenhart, Echt (NL); Martin Antonius van Es, Epen (NL); Mark Leo Hendrik Theunissen, Brunssum (NL); Maikel Renders, Valkenswaard (NL)

(21) Appl. No.: 18/277,806

(22) PCT Filed: Feb. 18, 2022
(86) PCT No.: PCT/EP2022/054076

§ 371 Date: Aug. 18, 2023

(30) Foreign Application Priority Data
Feb. 18, 2021 (EP) 21157928.9
Feb. 18, 2021 (EP) 21157932.1
Feb. 18, 2021 (EP) 21157935.4
Feb. 18, 2021 (EP) 21157966.9
Feb. 18, 2021 (EP) 21157969.3

(51) Int. Cl. C08F 10/06; C08J 9/14; C08K 3/34

(52) U.S. Cl. CPC C08F 10/06; C08J 9/141; C08K 3/34; C08J 2203/14; C08J 2323/12

(57) ABSTRACT

High melt strength polypropylene composition, wherein the high melt strength polypropylene composition comprises a high melt strength polypropylene, wherein the high melt strength polypropylene composition has a melt strength ≥45 cN, more preferably ≥50 cN, more preferably ≥55 cN, even more preferably ≥60 cN, even more preferably ≥65 cN, wherein the melt strength is determined in accordance with ISO 16790:2005 at a temperature of 200° C., using a cylindrical capillary having a length of 20 mm and a width of 2 mm, a starting velocity v₀ of 9.8 mm/s and an acceleration of 6 mm/s² and wherein the high melt strength polypropylene composition has a melt flow rate ≥1.0 and ≤4.0 g/10 min as determined in accordance with ASTM D1238 (2013) at a temperature of 230° C. under a load of 2.16 kg.

The invention relates to a high melt strength polypropylene composition, a foam comprising said high melt strength polypropylene composition, an article comprising the foam, a process for the preparation of said foam as well as to the use of the high melt strength polypropylene composition for the preparation of a foam.

Polymer foams are used in a wide range of applications, such as building and construction, automotive applications, household applications, such as food packaging and protective packaging; and consumer applications. Foams are popular because of their good mechanical rigidity, their good insulative properties and their cushioning against mechanical shock. In addition, the use of foams provides a significant contribution to the reduction in the use of raw materials. Moreover, the use of foams allows for a lightweight solution, which is not only of advantage from a cost perspective, but also from a transportation point of view as less energy is required to transport a lighter material.

Polypropylene foams are of advantage as compared to other polymer foams due to a number of reasons: polypropylene has good mechanical properties, in particular rigidity (stiffness), allows easy recycling (whereas, polystyrene for example requires further steps in waste separation processes), has a good chemical (oil and acid) resistance, a good thermal resistance and does not absorb water.

In order to foam polypropylene, long chain branched polypropylenes are commonly used. An example of such long chain branched polypropylene is Daploy™ WB140HMS commercially available from Borealis.

However, there is a continuous desire to improve long chain branched polypropylenes. For example, it is desired to improve the processing, recyclability and/or properties of the foam produced with the long chain branched polypropylenes. Furthermore, there is also pressure to lower the environmental impact of the polypropylene foams, for example by further downgauging and/or increasing recyclability.

It is the object of this invention to provide a high melt strength polypropylene composition which can achieve the preparation of foamed sheets having a higher bending stiffness while not increasing the environmental impact (that is while not increasing the amount of raw materials needed) while at the same time having a good surface appearance.

This object is achieved by a high melt strength polypropylene composition, wherein the high melt strength polypropylene composition comprises a high melt strength polypropylene, wherein the high melt strength polypropylene composition has a melt strength ≥45 cN, more preferably ≥50 cN, more preferably ≥55 cN, even more preferably ≥60 cN, even more preferably ≥65 cN, wherein the melt strength is determined in accordance with ISO 16790:2005 at a temperature of 200° C., using a cylindrical capillary having a length of 20 mm and a width of 2 mm, a starting velocity v₀ of 9.8 mm/s and an acceleration of 6 mm/s² and wherein the high melt strength polypropylene composition has a melt flow rate ≥1.0 and ≤4.0 g/10 min as determined in accordance with ASTM D1238 (2013) at a temperature of 230° C. under a load of 2.16 kg.

It was found that by using the high melt strength polypropylene composition of the invention, the overall bending stiffness of sheets prepared therefrom could be increased. Therefore, the high melt strength polypropylene composition of the invention having a melt strength ≥45 cN can suitably be used for applications requiring a higher overall bending stiffness. For applications requiring the same overall bending stiffness, it is possible to use less of the high melt strength polypropylene composition of the invention for obtaining the same overall bending stiffness, i.e. to prepare foamed sheets that are thinner and/or sheets that have a lower foam density. This so-called down-gauging is advantageous from an environmental point of view in terms of carbon footprint (less material and less transport costs and energy) as well as from an economical (cost) perspective.

Furthermore, the high melt strength polypropylene composition of the invention having a melt flow rate ≥1.0 and ≤4.0 g/10 min, preferably a melt flow rate ≥1.5 and ≤4.0 g/10 min as determined in accordance with ASTM D1238 (2013) at a temperature of 230° C. under a load of 2.16 kg leads to a better surface appearance of the sheets.

Another advantage of the high melt strength polypropylene composition of the invention having a melt flow rate ≥1.0 and ≤4.0 g/10 min as determined in accordance with ASTM D1238 (2013) at a temperature of 230° C. under a load of 2.16 kg is that it allows an increased throughput in a commercial foam extruder as it can be processed more easily.

A sheet as defined herein is a shape which has a longer length than width, and a larger width than thickness. The thickness of the sheet is in principle not critical, but may for example be ≥5 μm and ≤100 cm.

In the context of the invention, with ‘foamed’ or ‘foam’ is meant that the shape has a lower density due to the presence of gas bubbles (such as air) as compared to the density of the same material without gas bubbles.

### High Melt Strength Polypropylene Composition

High melt strength polypropylene compositions having a melt strength ≥45 cN can for example be obtained by the process as disclosed in WO2009/003930A1. WO2009/003930A1 discloses an irradiated polymer composition comprising at least one polyolefin resin and at least one non-phenolic stabilizer, wherein the irradiated polymer composition is produced by a process comprising mixing the polyolefin resin with the non-phenolic stabilizer and irradiating this mixture in a reduced oxygen environment. In addition, a high melt strength polypropylene having a melt strength ≥65 cN is available from SABIC as SABIC® PP UMS 561P as of 18 Feb. 2021.

Preferably, the high melt strength polypropylene composition is prepared by a) irradiation of a polypropylene composition with at least one non-phenolic stabilizer, preferably wherein the non-phenolic stabilizer is chosen from the group of hindered amines, wherein the irradiation is performed with ≥2.0 and ≤20 Megarad electronbeam radiation in a reduced oxygen environment, wherein the amount of active oxygen is ≤15% by volume with respect to the total volume of the reduced oxygen environment for a time sufficient for obtaining a long chain branched polypropylene and b) deactivation of the free radicals in the long chain branched polypropylene to form the high melt strength polypropylene composition. How to deactivate the free radicals is known in the art, for example by heating as described in WO2009003930A1.

Examples of non-phenolic stabilizers are known in the art and are for example disclosed on pages 37-60 of WO2009/003930A1, hereby incorporated by reference. Preferably, the non-phenolic stabilizer is chosen from the group of hindered amines. More preferably, the non-phenolic stabilizer comprises at least one hindered amine selected from the group of Chimassorb® 944, Tinuvin® 622, Chimassorb® 2020, Chimassorb® 119, Tinuvin® 770, and mixtures thereof, separate or in combination with at least one hydroxylamine, nitrone, amine oxide, or benzofuranone selected from N,N-di(hydrogenated tallow)amine (Irgastab® FS-042), an N,N-di(alkyl)hydroxylamine produced by a direct oxidation of N,N-di(hydrogenated tallow)amine (Irgastab® FS-042), N-octadecyl-α-heptadecylnitrone, Genox™ EP, a di(C16-C18)alkyl methyl amine oxide, 3-(3,4-dimethylphenyl)-5,7-di-tert-butyl-benzofuran-2-one, Irganox® HP-136 (BFI), and mixtures thereof, and separate or in combination with at least one organic phosphite or phosphonite selected from tris(2,4-di-tert-butylphenyl) phosphite (Irgafos® 168). Even more preferably, the non-phenolic stabilizers of the present subject matter can include those described in U.S. Pat. Nos. 6,664,317 and 6,872,764, both of which are incorporated herein by reference in their entirety.

Preferably, the melt strength of the high melt strength polypropylene composition is ≤100 cN, for example ≤95 cN, for example ≤90 cN, for example ≤87 cN. The melt strength of the high melt strength polypropylene composition is determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s2.

With polypropylene as used herein is meant propylene homopolymer, a copolymer of propylene with an α-olefin or a heterophasic propylene copolymer. Preferably, the high melt strength polypropylene composition comprises the high melt strength polypropylene in an amount of ≥95 wt %, more preferably ≥96 wt %, even more preferably ≥97 wt %, even more preferably ≥98 wt %, for example ≥99 wt %, for example ≥99.6 wt %, for example ≥99.8 wt %, for example ≥99.9 wt % based on the high melt strength polypropylene composition.

Preferably, the high melt strength polypropylene is a polypropylene chosen from the group of propylene homopolymers and propylene copolymers comprising moieties derived from propylene and one or more comonomers chosen from the group of ethylene and alpha-olefins with ≥4 and ≤12 carbon atoms.

Preferably, the propylene copolymer comprises moieties derived from one or more comonomers chosen from the group of ethylene and alpha-olefins with ≥4 and ≤12 carbon atoms in an amount of ≤10 wt %, for example in an amount of ≥1.0 and ≤7.0 wt % based on the propylene copolymer, wherein the wt % is determined using ¹³C NMR. For example, the propylene copolymer comprises moieties derived from one or more comonomer chosen from the group of ethylene, 1-butene, 1-pentene, 1-hexene, 4-methyl-1-pentene, 1-heptene, 1-octene, 1-decene and 1-dodecene, preferably moieties derived from ethylene.

Polypropylenes and the processes for the synthesis of polypropylenes are known. A propylene homopolymer is obtained by polymerizing propylene under suitable polymerization conditions. A propylene copolymer is obtained by copolymerizing propylene and one or more other comonomers, for example ethylene, under suitable polymerization conditions. The preparation of propylene homopolymers and copolymers is for example described in Moore, E. P. (1996) Polypropylene Handbook. Polymerization, Characterization, Properties, Processing, Applications, Hanser Publishers: New York.

Propylene homopolymers, propylene copolymers and heterophasic propylene copolymers can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Preferably, the high melt strength polypropylene composition has a VOC value as determined in accordance with VDA278 (2011-October) ≤250 μg/g, preferably a VOC value ≤50 μg/g and/or an FOG value as determined in accordance with VDA278 (2011-October) ≤500 μg/g, preferably an FOG-value ≤100 μg/g.

In another aspect, the invention relates to a foam comprising the high melt strength polypropylene composition of the invention. Preferably, the high melt strength polypropylene composition is present in the foam in an amount of ≥10 wt % based on the foam. For example, the amount of high melt strength polypropylene composition is ≥15 wt % and ≤99.9 wt %, for example ≥20 wt % and ≤99.5 wt %, for example ≥25 wt % and ≤99 wt %, for example ≥30 wt % and ≤98 wt %, for example ≥40 wt % and ≤97 wt %, for example ≥50 wt % and ≤96 wt %, preferably ≥60 wt % and ≤99.9 wt % based on the foam. Preferably, the high melt strength polypropylene composition is present in the foam in an amount ≥30 wt % and ≤99.9 wt % based on the foam.

The high melt strength polypropylene composition may further comprise additives, such as for example flame retardants, pigments, lubricants, slip agents flow promoters, antistatic agents, processing stabilizers, long term stabilisers and/or UV stabilizers. The additives may be present in any desired amount to be determined by the man skilled in the art, but are preferably present ≥0.001 wt % and ≤5.0 wt %, more preferably ≥0.01 wt % and ≤4.0 wt %, even more preferably ≥0.01 wt % and ≤3.0 wt % based on the high melt strength polypropylene composition.

In one embodiment, the foam further comprises a further polypropylene, preferably a further polypropylene in an amount ≥10 wt % and ≤90 wt %, for example in an amount ≥10 wt % and ≤40 wt % or in an amount ≥50 wt % and ≤90 wt % based on the foam. The further polypropylene can be a propylene homopolymer, a propylene copolymer, for example a copolymer of propylene with an α-olefin as described herein or a heterophasic propylene copolymer as described herein.

The foam may further comprise a nucleating agent. A nucleating agent may be desired to increase the cell density and to modify the dynamics of bubble formation and growth. (Gendron, Thermoplastic foam Processing, 2005, page 209).

The amount of nucleating agent may for example be ≥0.10 wt % and ≤5.0 wt %, for example ≥0.20 wt % and ≤4.0 wt %, for example ≥0.30 wt % and ≤3.0 wt %, preferably ≥0.40 wt % and ≤2.5 wt %, more preferably ≥0.50 wt % and ≤1.5 wt % based on the foam, most preferably ≥0.50 wt % and ≤1.2 wt % based on the foam.

Suitable nucleating agents include but are not limited to talc, silica and a mixture of sodium bicarbonate and citric acid. Other suitable nucleating agents include amides, for example azo dicarbonamide, amines and/or esters of a saturated or unsaturated aliphatic (C₁₀-C₃₄) carboxylic acid. Examples of suitable amides include fatty acid (bis)amides such as for example stearamide, caproamide, caprylamide, undecylamide, lauramide, myristamide, palmitamide, behenamide and arachidamide, hydroxystearamides and alkylenediyl-bis-alkanamides, preferably (C₂-C₃₂) alkylenediyl-bis-(C₂-C₃₂) alkanamides, such as for example ethylene bistearamide (EBS), butylene bistearamide, hexamethylene bistearamide, ethylene bisbehenamide and mixtures thereof. Suitable amines include or instance (C₂-C₁₈) alkylene diamines such as for example ethylene biscaproamine and hexamethylene biscaproamine. Preferred esters of a saturated or unsaturated aliphatic (C₁₀-C₃₄) carboxylic acid are the esters of an aliphatic (C₁₆-C₂₄) carboxylic acid. Preferably, the nucleating agent is chosen from the group of talc, sodium bicarbonate, citric acid, azodicarbonamide and mixtures thereof, more preferably the nucleating agent is talc.

For the preparation of the foam, it may be desired to use a cell stabilizer. Cell stabilizers are permeability modifiers which retard the diffusion of for example hydrocarbons such as isobutene to create dimensionally stable foams. (Gendron, Thermoplastic foam Processing, 2005, pages 31 and 149) Preferred cell stabilizers include but are not limited to glycerol monostearate (GMS), glycerol monopalmitate (GMP), palmitides and/or amides. Suitable amides are for example stearyl stearamide, palmitide and/or stearamide. Suitable mixtures include for example a mixture comprising GMS and GMP or a mixture comprising stearamide and palmitamide. Preferably, in case a cell stabilizer is used, the cell stabilizer is glycerol monostearate or stearamide. The amount of cell stabiliser to be added depends on desired cell size and the composition used for the preparation of the foam. Generally, the cell stabiliser may be added in an amount ≥0.10 and ≤3.0 wt % relative to the foam.

Preferably, the density of the foam is ≤750 kg/m³ and ≥15 kg/m³, preferably ≤500 kg/m³ and ≥25 kg/m³, wherein the density is determined according to ISO 845 (2006).

Preferably, the foam has an open cell content of ≤15.0%, preferably ≤12.0%, more preferably ≤10.0%, even more preferably ≤7.0%, even more preferably ≤5.0%, even more preferably ≤4.0%, even more preferably ≤3.0%, even more preferably ≤2.0%, wherein the open cell content is determined according to ASTM D6226-10.

Processes for preparating polypropylene foams and foamed sheets are within the knowledge of the person skilled in the art. In such a process, a melt of the high melt strength polypropylene composition mixed with a gaseous or liquid blowing agent agent is suddenly expanded through a pressure drop. Continuous foaming processes as well as discontinuous processes may be applied. In a continuous foaming process, the polypropylene composition is melted and laden with gas in an extruder under pressures typically above 20 bar before being extruded through a die where the pressure drop causes the formation of a foam. The mechanism of foaming polypropylene in such foam extrusion process is explained, for example, in H. E. Naguib, C. B. Park, N. Reichelt, Fundamental foaming mechanisms governing the volume expansion of extruded polypropylene foams, Journal of Applied Polymer Science, 91, 2661-2668 (2004). Processes for foaming are outlined in S. T. Lee, Foam Extrusion, Technomic Publishing (2000). In a discontinuous foaming process, the polypropylene composition (micro-)pellets are laden with foaming agent under pressure and heated below melting temperature before the pressure in the autoclave is suddenly relaxed. The dissolved foaming agent forms bubbles and creates a foam structure.

Therefore, the invention also relates to a foam, wherein the foam is prepared by a foam extrusion process, an autoclave process, an injection molding process, a blow-molding process or a rotomolding process.

In case the foam of the invention is a foamed sheet, preferably the foamed sheet is prepared by a foam extrusion process.

In another aspect, the invention relates to a process for the preparation of the foam of the invention. In particular, the invention also relates to a process for the preparation of a foam, comprising the sequential steps of:
a) providing the high melt strength polypropylene composition of the invention and
b) adding a blowing agent and optionally adding a nucleating agent and/or optional further polypropylene to the high melt strength polypropylene composition, for example wherein the blowing agent is added in an amount ≥0.10 wt % and ≤20 wt % based on the high melt strength polypropylene composition, the optional nucleating agent and optional further polypropylene and
c) subjecting the mixture of the high melt strength polypropylene composition, the blowing agent and the optional nucleating agent and the optional further polypropylene to a foaming process to prepare the foam.

The amount of blowing agent for example depends on the desired density and the polymer composition used. For example, the blowing agent may be used in an amount ≥0.10 wt % and ≤20 wt % based on the polymer composition.

Examples of suitable physical blowing agents include, but are not limited to isobutane, CO2, pentane, butane, nitrogen and/or a fluorohydrocarbon. Preferably, the physical blowing agent is isobutane and/or CO2, most preferably isobutane.

Examples of suitable chemical blowing agents include, but are not limited to citric acid or a citric acid-based material (e.g. mixtures of citric acid and sodium bicarbonate) and azo dicarbonamide. Such chemical blowing agents are for example commercially available from Clariant Corporation under for example the name Hydrocerol™ CF-40E™ or Hydrocerol™ CF-05E™.

Foamed sheets thus prepared may be stretched monoaxially or biaxially using a manner known per se.

Therefore, the invention also relates to a process for the preparation of foamed sheets, comprising the sequential steps of:
a) providing the high melt strength polypropylene composition of the invention and
b) adding a blowing agent to the high melt strength polypropylene composition and optionally adding a further polypropylene, a nucleating agent and/or a cell stabilizer and
c) subjecting the mixture of the high melt strength polypropylene composition, the blowing agent and the optional nucleating agent and the optional further polypropylene and the optional cell stabilizer to a foaming process, preferably a foam extrusion process to form the foamed sheet and
d) stretching the foamed sheet in at least one direction.

The invention also relates to the foamed sheet prepared from the high melt strength polypropylene composition of the invention, which foamed sheet is stretched in at least one direction, for example the invention relates to the foamed sheet of the invention, wherein the foamed sheet is monoaxially stretched (for example in the machine direction) or for example, the invention relates to the foamed sheet of the invention wherein the foamed sheet is biaxially stretched, for example in both the machine direction (MD) and in the transverse direction (MD). As is known to the person skilled in the art, the stretching in MD and TD may be carried out simultaneously, or in consecutive steps.

The draw ratio in MD may for example be ≥1.1 and ≤7.0, for example ≥1.1 and ≤3.0. The draw ratio in transverse direction may for example be ≥1.1 and ≤7.0, for example ≥1.1 and ≤3.0.

In another aspect, the invention relates to the use of the high melt strength polypropylene composition of the invention for the preparation of a foam.

The foams of the invention can suitably be used in applications such as building and construction, automotive applications, household applications, such as food packaging and protective packaging; and consumer applications. For example, the foams can be used for the preparation of cups, trays, containers, bottles, seals, returnable boxes. Other applications of the foams of the invention are for example: sandwich panels, pipe insulations, concrete joint fillers, insulation materials for houses, water tanks or floors (floor underlayments).

The very good cushioning properties of the foam of the invention offer the user safety and comfort. The foam is applicable in multiple applications requiring non-slip performance, such as footwear, protective guards, sports floor mats and foam rollers. In another aspect therefore, the invention relates to an article comprising the foam of the invention, for example wherein the article is a sheet, film, profile, rod or tube.

In yet another aspect, the invention relates to use of the foam of the invention in an applications such as building and construction, automotive applications, household applications, such as food packaging and protective packaging; and consumer applications.

The invention also relates to the use of the foam of the invention for the preparation of an article, for example wherein the article is a cup, tray, container, bottle, seal, reusable boxes, a sandwich panel, a pipe insulation, a concrete joint filler, an insulation material for houses, water tanks or floors (floor underlayments), footwear, a protective guard, a (sports) floor mat or a foam roller.

The foam of the invention can be used as a replacement for applications wherein polystyrene foam is typically used, such as disposable food containers.

It is noted that the invention relates to the subject-matter defined in the independent claims alone or in combination with any possible combinations of features described herein, preferred in particular are those combinations of features that are present in the claims. It will therefore be appreciated that all combinations of features relating to the compositions according to the invention; all combinations of features relating to the processes according to the invention and all combinations of features relating to the compositions according to the invention and features relating to the processes according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

### Methods Used:

### Melt Flow Rate

The melt flow rate of the polymers was determined in accordance with ASTM D1238 (2013) at a temperature of 230° C. (MFR₂₃₀) under a load of 2.16 kg.

### Melt Strength

Melt strength was measured according to ISO standard 16790:2005. Melt strength is defined as the maximum (draw-down) force (in cN) by which a molten thread can be drawn before it breaks, e.g. during a Rheotens measurement. Measurements were done on a Göttfert Rheograph 6000 at a temperature of 200° C. with a setup like shown in FIG. 1 of ISO standard 16790:2005. The rheometer has an oven with a diameter of 12 mm. A capillary of 20 mm length and 2 mm width was used. The entrance angle of the capillary was 180° (flat). The piston in the rheometer moved with a velocity of 0.272 mm/s to obtain an exit velocity v0, of 9.8 mm/s. After filling the rheometer, the melt was held in the rheometer for 5 minutes, to stabilize the temperature and fully melt the polymer. The strand that exits the capillary was drawn with a Rheotens II from Goettfert with an acceleration of 6 mm/s² until breakage occurred. The distance between the exit of the capillary and the uptake wheels of the Rheotens II (=draw length) was 100 mm.

The pressure required to push the melted polymer through the capillary, the maximum drawing force (=Melt strength) and the maximum draw ratio at breakage were recorded.

### Flexural-Modulus

The flexural-modulus of samples of the foamed sheets was determined with a three-point bending test according to ISO1209-2 Rigid cellular plastics—Determination of flexural properties, using a testing speed of 20 mm/min. Samples having a span of 60 mm and a width of 20 mm were cut from the foamed sheets. The samples were cut in the machine direction (MD, extrusion direction) and in the transverse direction (TD, direction perpendicular to the extrusion direction and perpendicular to the thickness direction), such that the thickness of the foamed sheet (as indicated in Table 2) was maintained. As used herein, thickness direction is the size of the foamed sheet with the smallest dimension.

Flexural modulus average is the average of the flexural modulus MD and the flexural modulus TD.

### Foam Density

Density of the foam (kg/m³) is the apparent overall density and was determined according to ISO 845:2006.

### Thickness and Width

Thickness and width of the foamed sheets were determined without applying pressure to the sheets.

### Open Cell Content

The open cell content was determined by using a Quantachrome Pentapyc 5200e gas pycnometer using a method based on ASTM D6226-10. The volume from the external dimensions of the sample was determined by using the Archimedes' principle by immersing the sample in water. It was assumed that the uptake of water by the sample can be neglected. After drying the sample from adhering water, the sample volume (V_{SPEC}) was determined by the pycnometer according ASTM D6226-10 at different pressures.

All applied pressures were below 0.1 bar to minimize compression of the foam.

$${V}_{SPEC} = {V}_{CHAMBER} - {V}_{EXP} / [ \frac{{P}_{1}}{{P}_{2}} - 1 ]$$

Where:
V_{SPEC}=Volume Sample
V_{CHAMBER}=Volume sample chamber
V_{EXP}=Expansion volume

The sample volume of the foam was plotted against the applied pressures (0.090 bar; 0.075 bar, 0.060 bar, 0.045 bar, 0.035 bar, 0.020 bar and 0.010 bar). A straight line was fit through the measurement points, using linear regression. The interception of the linear regression line with the Y-axis at p=0 bar is the volume (V_{SPEC_0}) used in equation below.

The open cell content Vₒₚₑₙ (%) was calculated using the following formula:

O_{V}=[(V−V_{SPEC_0})/V]*100

Where:
O_{V}=open cell content [%]
V=Geometric volume
V_{SPEC_0}=Volume sample interpolated to a pressure of 0 bar

### Materials Used:

PP-UMS1 is a long chain branched propylene homopolymer which is commercially available from SABIC as SABIC® PPUMS 561P as of 18 Feb. 2021 without confidentiality restrictions, having a melt flow rate MFR₂₃₀ of 2.5 g/10 min and a melt strength of 71 cN. SABIC® PPUMS 561P has a VOC-value as measured in accordance with VDA278 (2011-10) within 7 days of its production of 10.9 μg/g. SABIC® PPUMS 561P has a FOG-value as measured in accordance with VDA278 (2011-October) within 7 days of its production of 56.4 μg/g.

PP-HMS is a long chain branched propylene homopolymer which is commercially available from Borealis as Daploy™ WB140HMS. It has a melt flow rate of MFR₂₃₀ of 2.2 g/10 min and a melt strength of 42 cN.

PP-UMS2 is an experimental long chain branched propylene homopolymer having a melt flow rate MFR₂₃₀ of 0.23 g/10 min and a melt strength of 62 cN. This PP-UMS2 is prepared as described in WO2009/003930A1, sample 11 (Polymer B) with 0.05 pph Genox EP.

Talc is TALCOLIN PP70+ which is a propylene homopolymer masterbatch with 70 wt % of talc (d50 of 9 μm), which is commercially available from JM Polymers.

### Blowing Agent is Isobutane.

### Preparation of the Foamed Sheets

The preparation of the foamed sheets was performed on a 30 mm double screw foam extruder from Theysohn having a length over diameter ratio (l/d) of 40. This extruder consists of nine electrical heating zones equipped with water cooling followed by a cooling section, static mixer and a die. For CE5, it is expected that the temperature in front of the cooling section increases by approximately 5° C. relative to the experiments with PP-UMS1. Isobutane was added as a physical blowing agent in an amount of 2.5 wt % based on the composition of Table 1 and introduced in the polymer melt in the 8^{th} zone of the extruder. A slit die adjustable in thickness was used for the production of the foamed sheets. The die pressure was adapted by adjusting the thickness of the slit die such that the pressure at the die was 50 bar. A slit die having a width of 35 mm was used.

The foamed sheets were then stretched in machine direction at the draw ratio indicated in Table 2 using a double belt drawing unit. The thus obtained sheets were then cooled in a water cooled calibration unit to fix the dimensions of the prepared foamed sheets. The draw ratio was adjusted by adjusting the speed of the double belt unit to the exit speed of the foam at free expansion. At a draw ratio of 1, the exit speed of the foam at free expansion (vₑₓᵢₜ) equals the speed of the double-belt unit (v_{line-speed}).

Table 1 reports the high melt strength polypropylene compositions, the foaming extrusion conditions and results.

TABLE 1
compositions used, foaming conditions and results

| | | | | | | | | |
|---|---|---|---|---|---|---|---|---|
| E1 | E2 | E3 | E4 | CE1 | CE2 | CE3 | CE4 | CE5 |

composition

| | | | | | | | | | | |
|---|---|---|---|---|---|---|---|---|---|---|
| PP-UMS1 | wt % | 97.9 | 97.9 | 97.9 | 97.9 | | | 97.9 | | |
| PP-HMS | wt % | | | | | 97.9 | 97.9 | | 97.9 | |
| PP-UMS2 | wt % | | | 2.1 | 2.1 | | | | | 97.9 |
| talc | wt % | 2.1 | 2.1 | | | 2.1 | 2.1 | 2.1 | 2.1 | 2.1 |

conditions

| | | | | | | | | | | |
|---|---|---|---|---|---|---|---|---|---|---|
| die pressure | bar | 50 | 50 | 50 | 50 | 50 | 50 | 50 | 50 | 50 |
| draw ratio | | 1 | 1.31 | 1.63 | 1.95 | 1 | 1.34 | 1.66 | 1.95 | 1 |
| line speed | m/min | 7.5 | 9.9 | 12.3 | 14.7 | 7.3 | 9.8 | 12.2 | 14.3 | 5 |

results

| | | | | | | | | | | |
|---|---|---|---|---|---|---|---|---|---|---|
| density | kg/m³ | 100 | 100 | 100 | 100 | 100 | 100 | 100 | 100 | 100 |
| thickness | mm | 2.3 | 2.0 | 1.9 | 1.6 | 2.5 | 2.2 | 1.9 | 1.8 | 2.5 |
| width | mm | 112 | 91 | 79 | 74 | 95 | 83 | 77 | 71 | 95 |
| flexural modulus | MPa | 88 | 106 | 142 | 159 | 90 | 120 | 135 | 163 | |
| MD | | | | | | | | | | |
| flexural modulus | MPa | 54 | 50 | 36 | 45 | 42 | 30 | 27 | 21 | |
| TD | | | | | | | | | | |
| flexural modulus | MPa | 71 | 78 | 92 | 104 | 66 | 75 | 82 | 93 | |
| average | | | | | | | | | | |
| surface | | + | + | + | + | + | + | + | + | − |
| appearance | | | | | | | | | | |

+: surface of the sheets was smooth
−: surface of the sheets expected to be uneven

### CONCLUSION

As can be seen from Table 1, when preparing foamed sheets from a high melt strength polypropylene composition having a melt strength ≥45 cN in accordance with the invention, a higher flexural modulus average is obtained as compared to foamed sheets prepared from a high melt strength polypropylene composition having a melt strength <45 cN (compare examples E1-E4 to CE1-CE4). The flexural modulus average is a measure for the overall bending stiffness.

Therefore, the high melt strength polypropylene composition of the invention can suitably be used for applications requiring a higher overall bending stiffness. For applications requiring the same overall bending stiffness, it is possible to use less of the high melt strength polypropylene composition of the invention for obtaining the same overall bending stiffness, i.e. to prepare foamed sheets that are thinner and/or sheets that have a lower foam density. This so-called down-gauging is advantageous from an environmental point of view in terms of carbon footprint (less material and less transport costs and energy) as well as from an economical (cost) perspective.

Furthermore, the high melt strength polypropylene composition of the invention having a melt flow rate ≥1.0 and ≤4.0 g/10 min as determined in accordance with ASTM D1238 (2013) at a temperature of 230° C. under a load of 2.16 kg will lead to a better surface appearance of the sheets (see examples E1-E4) as compared to sheets prepared from a high melt strength polypropylene composition having a melt flow rate of <1.0 g/10 min (see CE5 having a melt flow rate of 0.23 g/10 min).

Another advantage of the high melt strength polypropylene composition of the invention having a melt flow rate ≥1.0 and ≤4.0 g/10 min, preferably a melt flow rate ≥1.5 and ≤4.0 g/10 min as determined in accordance with ASTM D1238 (2013) at a temperature of 230° C. under a load of 2.16 kg is that the extruder can be operated at a lower temperature as compared to CE5 where the temperature in front of the cooling section is expected to increase by 5° C. as compared to E1-E4 and CE1-CE4. In commercial foam extruders this increase of temperature is undesired as this limits the maximum throughput.

1. High melt strength polypropylene composition, wherein the high melt strength polypropylene composition comprises a high melt strength polypropylene,
wherein the high melt strength polypropylene composition has a melt strength ≥45 cN, or ≥50 cN, or ≥55 cN, or ≥60 cN, or ≥65 cN, wherein the melt strength is determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s2 and wherein the high melt strength polypropylene composition has a melt flow rate ≥1.0 and ≤4.0 g/10 min, or a melt flow rate ≥1.5 and ≤4.0 g/10 min, as determined in accordance with ASTM D1238 (2013) at a temperature of 230° C. under a load of 2.16 kg.

2. High melt strength polypropylene composition, wherein the melt strength of the high melt strength polypropylene composition is ≤95 cN, or ≤90 cN, or ≤87 cN.

3. High melt strength polypropylene composition according to claim 1, wherein the high melt strength polypropylene in the high melt strength polypropylene composition is chosen from the group of propylene homopolymers and propylene copolymers comprising moieties derived from propylene and one or more comonomers chosen from the group of ethylene and alpha-olefins with ≥4 and ≤12 carbon atoms, or ethylene and/or wherein the high melt strength polypropylene composition comprises the high melt strength polypropylene in an amount of ≥95 wt %, or ≥96 wt %, or ≥97 wt %, or ≥98 wt %, or ≥99 wt %, or ≥99.6 wt %, or ≥99.8 wt %, or ≥99.9 wt % based on the high melt strength polypropylene composition.

4. High melt strength polypropylene composition according to claim 1, wherein the high melt strength polypropylene composition further comprises ≥0.001 wt % and ≤5.0 wt % additives based on the high melt strength polypropylene composition.

5. High melt strength polypropylene composition according to claim 1, wherein the high melt strength polypropylene composition is prepared by
a) irradiation of a polypropylene composition with at least one non-phenolic stabilizer, wherein the non-phenolic stabilizer is chosen from the group of hindered amines, wherein the irradiation is performed with ≥2.0 and ≤20 Megarad electron beam radiation in a reduced oxygen environment, wherein the amount of active oxygen is ≤15% by volume with respect to the total volume of the reduced oxygen environment for a time sufficient for obtaining a long chain branched polypropylene and
b) deactivation of the free radicals in the long chain branched polypropylene to form the high melt strength polypropylene composition.

6. Foam comprising the high melt strength polypropylene composition of claim 1, wherein the high melt strength polypropylene composition is present in an amount ≥10 wt % based on the foam, or wherein the high melt strength polypropylene composition is present in an amount ≥30 wt % and ≤99.9 wt % based on the foam.

7. Foam according to claim 6, further comprising a further polypropylene, or further polypropylene in an amount ≥10 wt % and ≤90 wt % based on the foam.

8. Foam according to claim 7, wherein the further polypropylene is a polypropylene chosen from the group of propylene homopolymers, propylene copolymers and heterophasic propylene copolymers.

9. Foam according to claim 6, wherein the foamed sheet further comprises a nucleating agent, wherein the nucleating agent is present in an amount ≥0.10 wt % and ≤5.0 wt % based on the foam and/or wherein the nucleating agent is chosen from the group of talc, sodium bicarbonate, citric acid, azodicarbonamide and mixtures thereof.

10. Foam according to claim 6, wherein the density of the foam is ≤750 kg/m3 and ≥15 kg/m3, wherein the density is determined according to ISO 845 (2006) and/or wherein the foamed sheet has an open cell content of ≤15.0%, wherein the open cell content is determined according to ASTM D6226-10.

11. Foam according to claim 6, wherein the foam is prepared by a foam extrusion process, an autoclave process, an injection molding process, a blow-molding process or a rotomolding process.

12. Article comprising the foam of claim 6, for example wherein the article is a sheet, film, profile, rod or tube.

13. Process for the preparation of a foam, comprising the sequential steps of:
d) providing the high melt strength polypropylene composition of claim 1 and
e) adding a blowing agent and optionally adding a nucleating agent and/or optional further polypropylene to the high melt strength polypropylene composition, wherein the blowing agent is added in an amount ≥0.10 wt % and ≤20 wt % based on the high melt strength polypropylene composition, the optional nucleating agent and optional further polypropylene and
f) subjecting the mixture of the high melt strength polypropylene composition, the blowing agent and the optional nucleating agent and the optional further polypropylene to a foaming process to prepare the foam.

14. Use of the high melt strength polypropylene composition of claim 1 for the preparation of a foam.
